(19) United States
(12) Patent Application Publication
(10) Pub. No.: US 2001/0050614 A1
(43) Pub. Date: Dec. 13, 2001

(54) Warning device for in-car use of mobile phones

(76) Inventor: Bill Yang, Taipei (TW)

Correspondence Address: J C Patents Inc, Suite 114, 1340 Reynolds Ave, Irvine, CA, 92614, US

(21) Appl. No.: 09/557,514

(22) Filed: Apr. 25, 2000

(30) Foreign Application Priority Data
Feb. 21, 2000 (TW) 89202858

(51) Int. Cl. B60Q 1/00

(52) U.S. Cl. 340/540; 340/425.5

(57) ABSTRACT

A warning device for in-car use of mobile phones. In accordance with the invention, suitable for use in a car, includes a detecting device, a driving device and a displaying device. The detecting device is used to generate a detecting signal that indicates in-car use of a mobile phone. The driving device is used to receive the detected signal and then to transmit a driving signal. The displaying device is used to receive the driving signal and then to emit a warning signal to warn other nearby cars to keep safe a distance from the car.

### CROSS-REFERENCE TO RELATED APPLICATION

This application claims the priority benefit of Taiwan application serial no. 89202858, filed Feb. 21, 2000.

### BACKGROUND OF THE INVENTION

1. Field of the Invention

The invention relates to a warning device, and in particular to a warning device for in-car use of mobile phones or cellular phones, which can effectively warn other nearby cars to take extra caution, in order to prevent car accidents when simultaneously driving a car and using a mobile phone.

2. Description of the Related Art

Currently, owing to the ubiquity of mobile phones or cellular phones, many drivers frequently contact family or friends while commuting.. However, according to a great number of reports issued in various magazines and newspapers, many medical specialists and scholars have made numerous experiments. Reports clearly indicate that drivers are not capable of driving with extra caution while using a mobile phone. The driver's reaction is thus slowed while performing such operations as turn-signaling and brake-pedaling, and the driver's ability to judge the road conditions is also affected. As a result, the incidents of innumerable losses of property and life-threatening car accidents are more likely to occur under such adverse conditions.

In a similar situation where extra caution is required. a new driver on the road will often post a sign or install a device to indicate to nearby pedestrians and drivers to take caution. Another example is that in recent years, owing to the addition of a third brake light on cars, car accidents have decreased significantly.

### SUMMARY OF THE INVENTION

In view of the above, the invention is to provide a warning device for in-car use of mobile phones or cellular phones. As soon as one uses a mobile phone while driving,, the warning device of the invention will immediately alert other nearby cars by emitting a signal from the car interior or exterior, to indicate that the driver is using a mobile phone. This signal alerts nearby pedestrians and drivers not to get too close to the car, and can thereby prevent car accidents. In accordance with the invention, the warning device for in-car use of mobile phonesis suitable for use in a car,. As soon as a mobile phone is being used in the car, the warning device sends a signal that indicates . in-car use of a mobile phone. The warning device that indicates in-car use of a mobile phone includes: a detecting device, a driving device and a displaying device.

The above-mentioned detecting device first detects when a mobile phone is in use, and then sends out a detecting signal to the driving device. After the driving device receives the detecting signal, it sends a signal out to the displaying device on the car. Hence, the use of the above-mentioned detecting device is that it can detect transmission and reception of mobile phone radio frequency signals. Additionally, a flashing device can be installed onto the displaying device on the interior or the exterior of the car. Furthermore, the flashing device can be designed into an icon of a mobile phone, or into any other design or words etc. that would attract attention and warn pedestrians and drivers of in-car use of a mobile phone. The power source of the flashing device can be from an external battery installed on the body of the car or directly from the car itself. Moreover, the displaying device can also utilize space on such apparatus as the signal indicator, brake lights, the third brake light and headlights, using the different signal flashes and different colours as a way of indication to others.

### BRIEF DESCRIPTION OF THE DRAWINGS

The invention, and its object, features and advantages will become more fully understood from the detailed description given hereinafter, and the accompanying drawings which are given by way of illustration only, and thus do not limit the present invention, and wherein:

FIG. 1 is a block circuit diagram showing a warning device for in-car use of mobile phones according to a preferred embodiment of the invention.

### DETAILED DESCRIPTION OF THE PREFERRED EMBODIMENTS

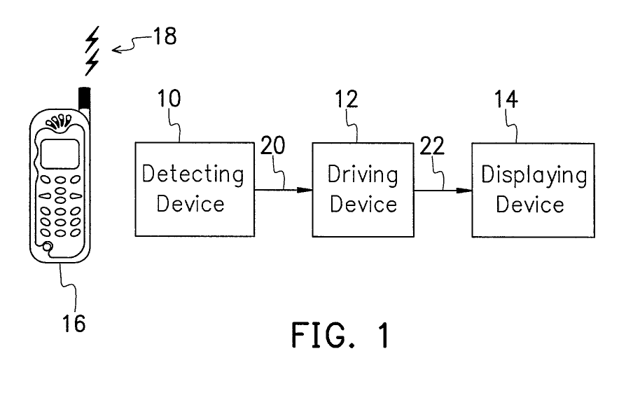

Referring to FIG. 1, a warning device for in-car use of mobile phones according to a preferred embodiment of the invention is shown. In FIG. 1, the warning device for in-car-use of mobile phones includes a detecting device 10, a driving device 12 and a displaying device 14. When a driver drives a car (not shown) and simultaneously uses a mobile phone 16, the detecting device 10 detects a radio frequency signal 18 transmitted from the mobile phone 16, and then generates a detecting signal 20. The driving device 12 receives the detecting signal 20 via wire or wireless transmission, and then sends out a driving signal 22 to the displaying device 14. After receiving the driving signal 22, the displaying device 14 emits a warning signal to warn other nearbypedestrians and drivers to keep a safe distance away from the car in order to prevent car accidents.

The displaying device 14 can be a flashing device installed on the body of the car. A flashing devicesuch as a lamp, can indicate that a driver is using a mobile phone, so that other nearby pedestrians and drivers can be warned immediately to keep a safe distance away from the flash light-emitting car, thereby preventing the occurrence of car accidents . The flashing device can also be designed into an icon of a mobile phone, or into any other designs that would attract attention and warn pedestrians and drivers of in-car use of a mobile phone. Furthermore, the power for the flashing device can be supplied by an external battery or directly by the car itself. Also, the displaying device 14 can also utilize space on such apparatus on the car as the signal indicator, brake lights, the third brake light and headlights, using the different signal flashes and different colors as a way of indication to others..

Since car accidents usually occur within one-thousandth of a second, after the addition of this warning device for in-car use of mobile phones, it can alert nearby cars to take caution and to keep a safe distance, thereby preventing car accidents.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A warning device for in-car use of mobile phones, suitable for use in a car, comprising:
a detecting device for generating a detecting signal that indicates in-car use of a mobile phone;
a driving device for receiving the detecting signal and then transmitting a driving signal; and
a displaying device for receiving the driving signal and then transmitting a warning signal to warn other nearby cars to keep a safe distance from the car.

2. The warning device for in-car-use of mobile phones as defined in claim 1, wherein the detecting device is used to detect whether the mobile phone receives or transmits a radio frequency signal.

3. The warning device for in-car use of mobile phones as defined in claim 1, wherein the displaying device comprises a flashing device which is installed on the body of the car.

4. The warning device for in-car-use of mobile phones as defined in claim 3, wherein the flashing device is designed into an icon of a mobile phone.

5. The warning device for in-car use of mobile phones as defined in claim 3, wherein the displaying device further comprises an external battery for power supply.

6. The warning device for in-car use of mobile phones as defined in claim 3, wherein the displaying device is power supplied directly by the car itself.

7. The warning device for in-car use of mobile phones as defined in claim 1, wherein the displaying device is part of a turn signal indicator on the car.

8. The warning device for in-car use of mobile phones as defined in claim 1, wherein the displaying device is a part of a brake light on the car.

9. The warning device for in-car use of mobile phones as defined in claim 1, wherein the displaying device is a part of the headlights on the car.
